(19) United States
(12) Patent Application Publication
(10) Pub. No.: US 2026/0236208 A1
(43) Pub. Date: Aug. 13, 2026

(54) PRINT CONTROL SYSTEM, NON-TRANSITORY COMPUTER READABLE MEDIUM, INFORMATION PROCESSING DEVICE, PRINT SERVER, AND PRINTER DRIVER

(71) Applicant: FUJIFILM Business Innovation Corp., Tokyo (JP)

(72) Inventor: Makoto KONDO, Kanagawa (JP)

(73) Assignee: FUJIFILM Business Innovation Corp., Tokyo (JP)

(21) Appl. No.: 19/311,604

(22) Filed: Aug. 27, 2025

(30) Foreign Application Priority Data
Feb. 12, 2025 (JP) 2025-020803

(51) Int. Cl. G06F 3/12

(52) U.S. Cl. CPC G06F 3/1288; G06F 3/1205; G06F 3/1208; G06F 3/1258

(57) ABSTRACT

A print control system includes a processor configured to: hold print settings that do not specify printing devices; acquire data to be printed and specified information about the print settings specified by a user in instructing a server device to print the data; calculate information indicating details of a job to be executed when the data is printed in accordance with the specified information, using the data and the specified information that have been acquired; and request the server device connected to the printing devices to verify whether the job is executable with the information that has been calculated.

### CROSS-REFERENCE TO RELATED APPLICATIONS

This application is based on and claims priority under 35 USC 119 from Japanese Patent Application No. 2025-020803 filed Feb. 12, 2025.

### BACKGROUND

### i. Technical Field

The present disclosure relates to a print control system, a non-transitory computer readable medium, an information processing device, a print server, and a printer driver.

### ii. Related Art

For example, Japanese Unexamined Patent Application Publication No. 2022-150569 discloses a print system including an information processing device and a print server. The information processing device generates a print job to be printed via the print server by a printer registered in the print server. The print server transmits the print job received from the information processing device to a transmission destination corresponding to a specified printer. In the disclosed print system, the print server receives a request from the information processing device, transmits a request for a verification process to a transmission destination corresponding to a printer to be used, based on the received request, receives a verification result of the verification process performed by the transmission destination, and transmits the received verification result to the information processing device.

### SUMMARY

A case is considered where print settings held by a terminal device do not specify printing devices, and when a printing device is instructed to perform printing based on such print settings, it is verified whether printing can be performed as per the print settings. When such verification is performed only by comparing the print settings with the functions of the printing device, the result is that printing cannot be performed as per the print settings. However, it is conceivable that printing can be performed depending on data to be printed.

Aspects of non-limiting embodiments of the present disclosure relate to improving the accuracy of verification compared to a case where verification of whether printing can be performed as per print settings is performed without using data to be printed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a print control system including a processor configured to: hold print settings that do not specify printing devices; acquire data to be printed and specified information about the print settings specified by a user in instructing a server device to print the data; calculate information indicating details of a job to be executed when the data is printed in accordance with the specified information, using the data and the specified information that have been acquired; and request the server device connected to the printing devices to verify whether the job is executable with the information that has been calculated.

### BRIEF DESCRIPTION OF THE DRAWINGS

An exemplary embodiment of the present disclosure will be described in detail based on the following figures, wherein:

FIG. 1 is a diagram illustrating a cloud print system;

FIG. 2 is a diagram illustrating an example of a hardware configuration of a server;

FIG. 3 is a diagram illustrating an example of a hardware configuration of a user terminal;

FIG. 4 is a functional block diagram of the user terminal;

FIG. 5 is a diagram illustrating a print settings screen displayed on a display of the user terminal;

FIG. 6 is a flowchart illustrating an example of a processing procedure when printing using a cloud print service is executed from the user terminal;

FIG. 7 is a diagram illustrating an example of a verification result obtained by a print possibility determination unit;

FIG. 8 is a diagram illustrating an example of a screen for output printer selection displayed when the example of a verification result is received;

FIGS. 9A, 9B, and 9C are diagrams illustrating a verification method by the print possibility determination unit, in which FIG. 9A illustrates a first example, FIG. 9B illustrates a second example, and FIG. 9C illustrates a third example;

FIGS. 10A and 10B are diagrams illustrating other examples of the verification result obtained by the print possibility determination unit, in which FIG. 10A illustrates a first other example, and FIG. 10B illustrates a second other example;

FIG. 11 is a diagram illustrating another example of the screen for output printer selection displayed when the second other example of the verification result is received; and

FIG. 12 is a diagram illustrating a screen example displayed after print settings are changed.

### DETAILED DESCRIPTION

Hereinafter, an exemplary embodiment of the present disclosure will be described in detail with reference to the attached drawings.

### System Configuration

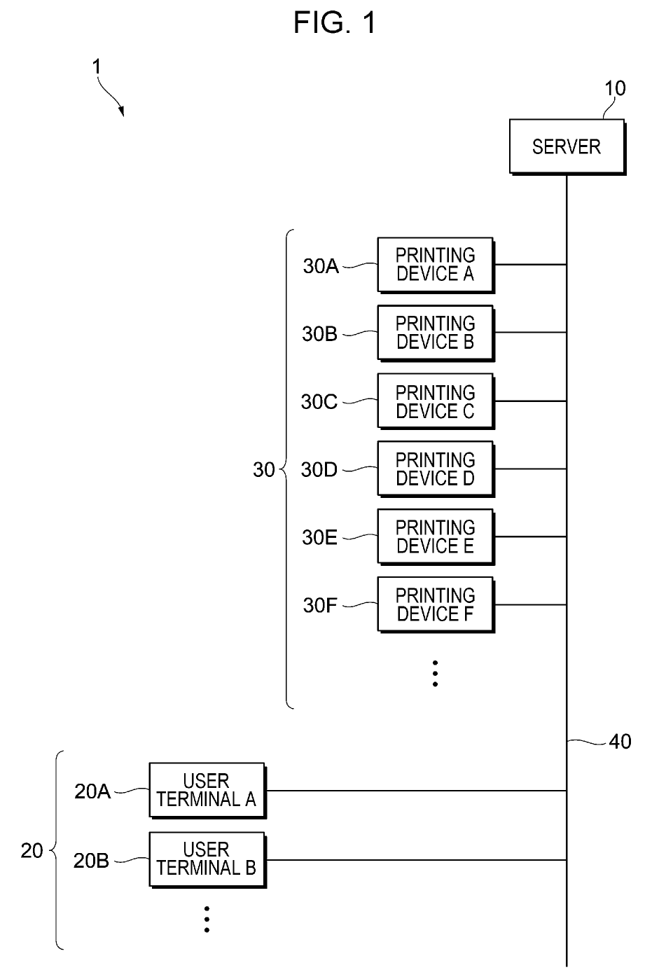

FIG. 1 is a diagram for describing a cloud print system 1. The cloud print system 1 includes a server 10 that provides a cloud print service, user terminals 20 each operated by a user, and printing devices 30 each connected to a cloud network 40.

A user of the cloud print service can cause the printing device 30 to execute printing from the user terminal 20 via the server 10. The cloud print service causes the printing device 30 to print data to be printed from an application of the user terminal 20. Such data printing is executed in accordance with the settings as to which paper the data is to be printed on, settings as to how the data is to be printed on the paper, settings as to whether to process the printed paper, and the like.

The cloud print service operates on the server 10.

The server 10 illustrated in FIG. 1 is a cloud server. The server 10 includes one or a plurality of servers. The server 10 manages the storage of a print job uploaded from the user terminal 20 and the output of a print job to the printing device 30 on which a user performs a login operation.

For example, the user terminal 20 illustrated in FIG. 1 is a desktop computer, a notebook computer, a tablet computer, or a smartphone. The user terminal 20 may be a so-called wearable terminal. Types of the wearable terminals include a wristwatch-type wearable terminal, a ring-type wearable terminal, and a glasses-type wearable terminal. Examples of the glasses-type wearable terminal include smart glasses and augmented reality (AR) glasses.

In FIG. 1, the user terminal 20 operated by a user A is referred to as a "user terminal A" or "user terminal 20A". Hereinafter, the term "user terminal 20" is used as a generic term for user terminals 20A, 20B, and the like.

The printing device 30 is a device having at least a function of printing a document on paper. In this sense, the printing device 30 is also referred to as an image forming device. While the printing device 30 may be a device dedicated to printing, the printing device 30 may also have other functions. Examples of the other functions include duplication printing (so-called copy printing), document reading (scanning), and faxing (facsimile).

The printing devices 30 illustrated in FIG. 1 may be installed at any locations, and exist at multiple locations. In FIG. 1, different printing devices 30 are referred to as "printing device A" or "printing device 30A". Hereinafter, the term "printing device 30" is used as a generic term for printing devices 30A, 30B, 30C, 30D, 30E, 30F, and the like.

### Configuration of Server

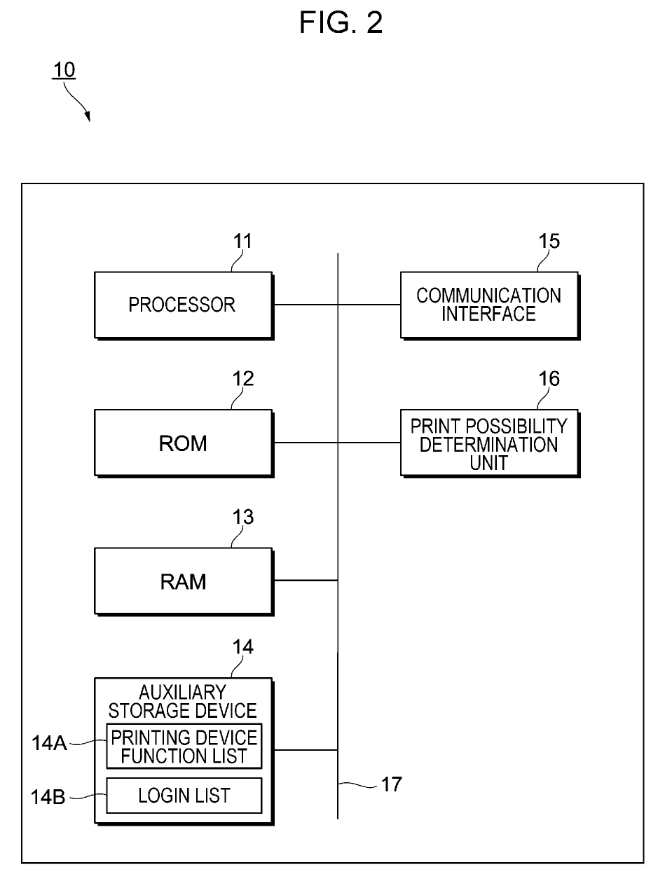

FIG. 2 is a diagram illustrating an example of a hardware configuration of the server 10.

The server 10 illustrated in FIG. 2 includes a processor 11 and a read-only memory (ROM) 12 that stores a basic input output system (BIOS) and the like. The server 10 also includes a random-access memory (RAM) 13 used as a work area for the processor 11 and an auxiliary storage device 14. The server 10 further includes a communication interface 15 and a print possibility determination unit 16. The devices are connected to each other via a signal line 17 such as a bus.

The processor 11 is a device that realizes various functions by executing a program. The processor 11, the ROM 12, and the RAM 13 function as a computer.

The communication interface 15 is an interface that realizes communication with the user terminal 20 and the printing device 30. The communication interface 15 complies with various communication standards. Examples of the communication standards include Ethernet (registered trademark), Wi-Fi (registered trademark), and a mobile communication system.

For example, the auxiliary storage device 14 includes a hard disk device or a semiconductor storage. The auxiliary storage device 14 stores programs and various types of data. The term "program" is used as a generic term for an operating system (OS) and application programs.

In the present exemplary embodiment, the auxiliary storage device 14 stores a printing device function list 14A and a login list 14B.

The printing device function list 14A is information indicating the functions or capabilities of each of the printing devices 30. For example, for each of the printing devices 30A to 30F, the printing device function list 14A indicates the availability of color printing, the availability of double-sided printing, the type of paper for printing, and the availability of processing to be performed on printed paper such as stapling.

The login list 14B is authentication information for identifying information predetermined for a user when the user logs in to the cloud print service. With such authentication information, for example, print settings and the printing device 30 can be identified for each user.

In response to a verification request from the user terminal 20, the print possibility determination unit 16 determines whether printing is possible by the printing device 30 that provides the cloud print service. Such determination is made using the above-described printing device function list 14A and job information from the user terminal 20. The job information will be described later.

The server 10 receives print data or job data including print settings and drawing data from the user terminal 20, and transmits the received print data to the printing device 30 or a proxy server (not illustrated).

The proxy server (not illustrated) communicates with the server 10 for transmission and reception of print settings and print data or the like on behalf of a printing device that does not support cloud print (not illustrated).

### Configuration of User Terminal

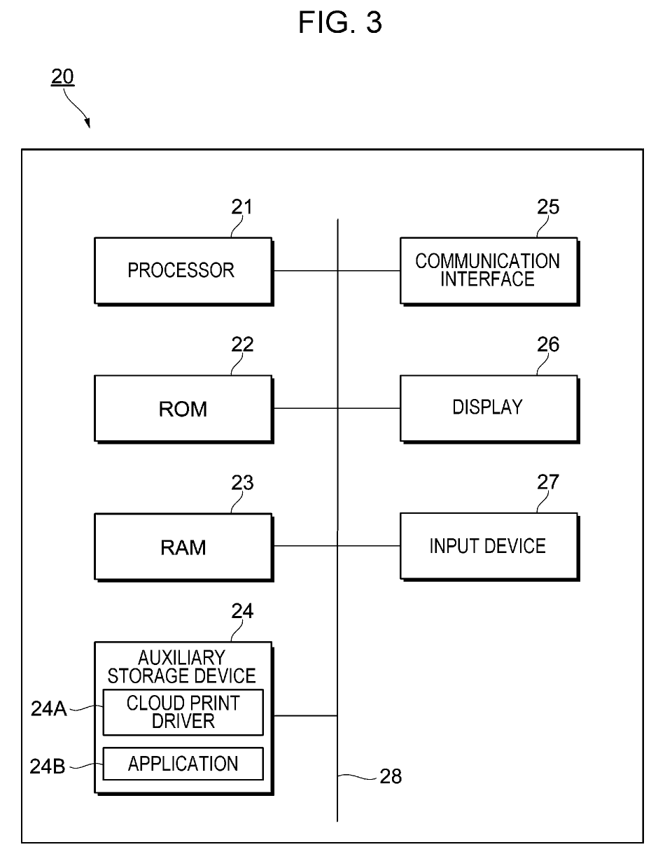

FIG. 3 is a diagram illustrating an example of a hardware configuration of the user terminal 20.

The user terminal 20 illustrated in FIG. 3 includes a processor 21, a ROM 22 that stores a BIOS and the like, a RAM 23 used as a work area for the processor 21, an auxiliary storage device 24, a communication interface 25, a display 26, and an input device 27. The devices are connected to each other via a signal line 28 such as a bus.

For example, the auxiliary storage device 24 includes a hard disk device or a semiconductor storage. The auxiliary storage device 24 stores programs and various types of data.

In the present exemplary embodiment, the auxiliary storage device 24 stores a cloud print driver 24A and an application 24B.

For example, the cloud print driver 24A is a print driver provided by an operator of the cloud print service.

The cloud print driver 24A is a universal printer driver compatible with any printing device 30 (see FIG. 1). That is, the cloud print driver 24A is a printer driver that provides a sum of the sets of functions of the printing devices 30A to 30F (see FIG. 1) supported by the cloud print service. This enables a user to execute printing that uses all the functions of the printing devices 30A to 30F in the cloud print service.

The cloud print driver 24A is not a printer driver that specifically identifies any one of the printing devices 30A to 30F (see FIG. 1). The cloud print driver 24A reflects the functions that can be realized by at least one printing device among the printing devices 30A to 30F connected to the server 10.

The cloud print driver 24A is an example of print settings that do not specify a printing device.

The application 24B is an application program for creation of document data and the like. When created document data or the like is to be printed, the application 24B configures the print settings by the cloud print driver 24A and transmits the data to be printed and the print settings to the cloud print service.

For example, the display 26 is a liquid crystal display or an organic electroluminescence (EL) display.

For example, the input device 27 is a mouse or a keyboard. When the user terminal 20 is a notebook computer, a tablet computer, or a smartphone, a capacitive touch sensor having transparency that does not hinder visual recognition of an image displayed on the display 26 is used as the input device 27. A device in which this type of touch sensor is combined with the display 26 is called a touch panel.

The cloud print driver 24A of the user terminal 20 is a universal printer driver that can be applied to any printing device 30 by using the cloud print service. However, it is difficult for a general user to know the functions of each printing device 30. For this reason, even when the printing device 30 that executes printing is specified, printing may not be performed in accordance with the settings of the cloud print driver 24A.

To prevent the occurrence of such a situation, a case is considered in which print settings are transmitted to the cloud print service and whether printing can be performed as per the settings is verified in advance. In such a case, "not printable" is determined when the functions required to perform printing as per the print settings do not match the functions of one printing device 30. However, there may be a case where printing can be performed by the functions of the one printing device 30 depending on the data to be printed. For example, when the color mode is selected in the print settings but the data to be printed is monochrome, printing is possible.

In view of this, the present exemplary embodiment employs a configuration in which whether printing is possible is verified using data to be printed and print settings.

Such verification may be performed by a user specifying, for example, the printing device 30C (see FIG. 1) from among the printing devices 30. Such verification may also be performed for all of the printing devices 30A to 30F (see FIG. 1) that can use the cloud print service without such specification by the user.

Description will be given below.

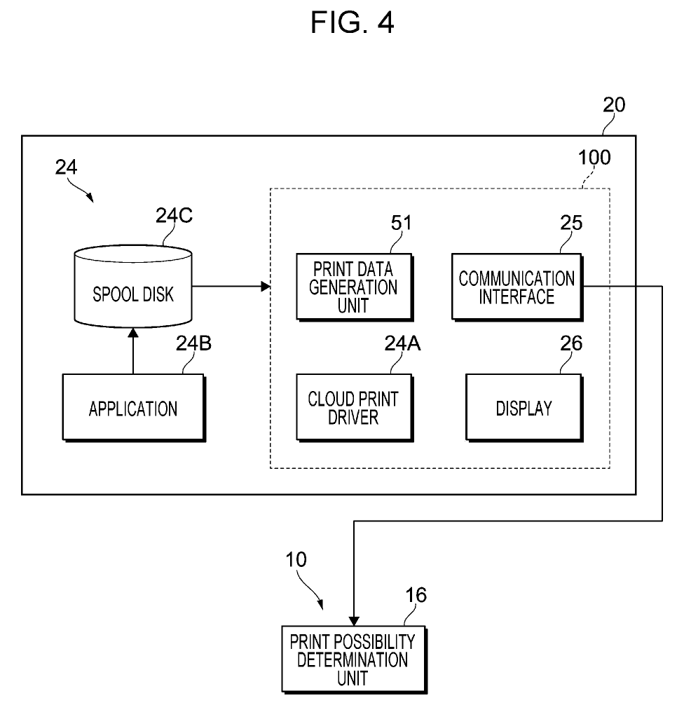

FIG. 4 is a functional block diagram of the user terminal 20.

As illustrated in FIG. 4, the auxiliary storage device 24 of the user terminal 20 includes a spool disk 24C that temporarily stores spool data such as document data sent from the application 24B.

The user terminal 20 includes a print data generation unit 51.

The print data generation unit 51 generates print data to be printed on paper by the printing device 30 using user-specified information that is information about print settings specified by a user and the spool data stored in the spool disk 24C.

The print data generation unit 51 also generates job information to be used for determination by the print possibility determination unit 16 of the server 10, by using the information on print settings specified by the user and the spool data in the spool disk 24C.

The print data generation unit 51, together with the cloud print driver 24A, the communication interface 25, and the display 26, constitutes a printer driver system 100 in the user terminal 20 (see the dashed line in FIG. 4).

In the present exemplary embodiment, each process is executed by any computer. The computer may execute these processes by using a processor serving as hardware, a program serving as software, or a combination of the processor and the program. In such a case, the processor executes various types of processes in the present exemplary embodiment in cooperation with the program, and may function as each unit or means in the present exemplary embodiment. The order in which the processor executes the processes is not limited to the described order, and may be changed as appropriate. The computer may be a general-purpose computer, an application-specific computer, a workstation, or another system capable of executing each process.

The processor may include one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

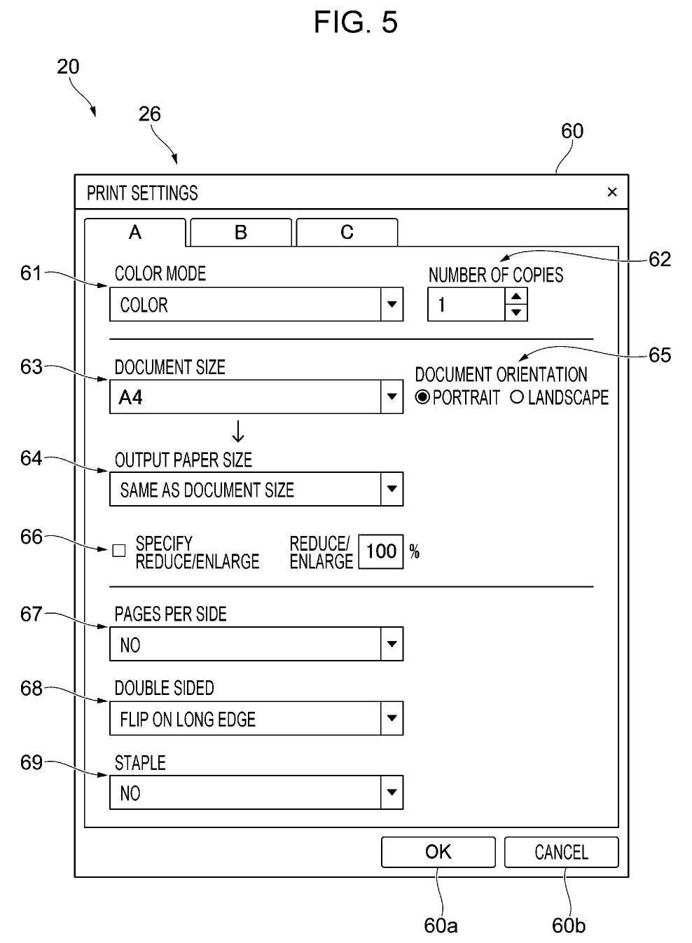

FIG. 5 is a diagram illustrating a print settings screen 60 displayed on the display 26 of the user terminal 20.

The print settings screen 60 includes tab A, tab B, and tab C for switching display. The example illustrated in FIG. 5 is a case where tab A is selected. In tab A, a color mode setting section 61, a number-of-copies setting section 62, a document size setting section 63, an output paper size setting section 64, a document orientation setting section 65, and a reduce/enlarge specifying section 66 are displayed. Further, in tab A, a pages-per-side setting section 67, a double-sided setting section 68, and a staple setting section 69 are displayed.

While the example illustrated in FIG. 5 is a case where the print settings screen 60 includes three tabs A to C, the configuration is not limited to this example. The print settings screen 60 may include less than three tabs or more than three tabs.

The print settings screen 60 also includes an "OK" button 60a for instructing proceeding to the next screen when the settings are complete. The print settings screen 60 also includes a "cancel" button 60b for instructing canceling the settings and return to the original screen.

The above-described color mode setting section 61 is an area in which the color mode of color printing can be selected. That is, the color mode setting section 61 is an area for instructing selection between the color mode and the monochrome mode of monochrome printing. The color mode setting section 61 is of a pull-down type in which selectable items are displayed in a list. The color mode may include a mode in which whether to perform color printing or monochrome printing is automatically determined based on print data and a mode in which color printing is always performed.

More specifically, when the color mode is specified in the color mode setting section 61 and the document is monochrome, monochrome printing is performed. That is, even when the color mode is specified, the same print result as that obtained when printing is performed in the monochrome mode is obtained.

The number-of-copies setting section 62 is an area for specifying the number of copies of paper on which print data is to be printed. The number-of-copies setting section 62 includes text "number of copies" and a portion indicating a number as the number of copies. For example, "1" is displayed as the default value of the number, and the number can be changed by operating a number-increasing button or a number-decreasing button.

The document size setting section 63 is an area indicating the size of a document created by the application 24B (see, for example, FIG. 4). In the document size setting section 63, the size displayed as the default value can be changed by pull-down. The document size is based on a paper standard such as A4 or A3.

The output paper size setting section 64 is an area indicating the size of paper for printing. In the output paper size setting section 64, for example, "same as document size" is displayed as the default value. In the output paper size setting section 64, as in the document size setting section 63, a paper size such as A4 or A3 can be specified by pull-down.

The document orientation setting section 65 is an area indicating the orientation of the document created by the application 24B (see, for example, FIG. 4). The document orientation setting section 65 includes text "document orientation", and a radio button is disposed for each of texts "portrait" and "landscape".

The reduce/enlarge specifying section 66 is an area for specifying reduce/enlarge (percentage) for a document created by the application 24B (see, for example, FIG. 4) when the document is printed on paper. In the reduce/enlarge specifying section 66, the text "specify reduce/enlarge" and a checkbox are displayed. In the reduce/enlarge specifying section 66, the text "reduce/enlarge", a portion indicating a numerical value as reduce/enlarge, and a symbol "%" are displayed side by side. The default value of the portion indicating a numerical value is 100, and a user is allowed to specify a numerical value by checking the checkbox.

The pages-per-side setting section 67 is an area for specifying that a plurality of documents are to be printed together on one page. For example, the default value is "no". In the pages-per-side setting section 67, "two sheets", which is an item for printing two documents together on one page of paper, "four sheets", which is an item for printing four documents together on one page of paper, or the like can be specified. The pages-per-side setting section 67 is also of a pull-down type.

More specifically, when "two sheets" is selected in the pages-per-side setting section 67 but the number of pages is one, the same print result as that obtained when "no" is selected is obtained.

The reduce/enlarge display and the checkbox of the above-described reduce/enlarge specifying section 66 may be automatically changed according to the specification in the pages-per-side setting section 67.

The double-sided setting section 68 is an area for specifying whether to perform double-sided printing or not. The double-sided setting section 68 is also an area for specifying the printing orientations of the front and back sides when double-sided printing is performed. That is, when double-sided printing is performed, "flip on long edge" for specifying printing for binding the long edges of paper and "flip on short edge" for specifying printing for binding the short edges of paper are selected.

For this reason, the double-sided setting section 68 specifies any one of "no", "flip on long edge", and "flip on short edge". The double-sided setting section 68 is also of a pull-down type.

More specifically, when "flip on short edge" is selected in the double-sided setting section 68 but the number of pages is one, the same print result as that obtained when double-sided printing is not performed is obtained.

The staple setting section 69 is an area for specifying whether to staple printed sheets of paper. In the staple setting section 69, either "no" indicating no stapling or "yes" indicating stapling can be specified. For example, the default value is "no". The staple setting section 69 is also of a pull-down type. The staple setting section 69 sets whether to perform stapling, which is an example of post-processing to be performed on printed paper. An area for specification may be provided for other types of postprocessing.

More specifically, when "yes" is specified in the staple setting section 69 but the number of sheets of paper is one, stapling is not performed. The number of sheets of paper being one includes not only the case of one document, but also a case where double-sided printing is performed for two documents. The number of sheets of paper being one also includes a case where, when there are four documents, for example, two documents are printed together on one sheet and double-sided printing is performed.

On the print settings screen 60, the type of paper, such as plain paper or high-quality paper, may be set. The type of paper is included in paper information together with the above-described paper size.

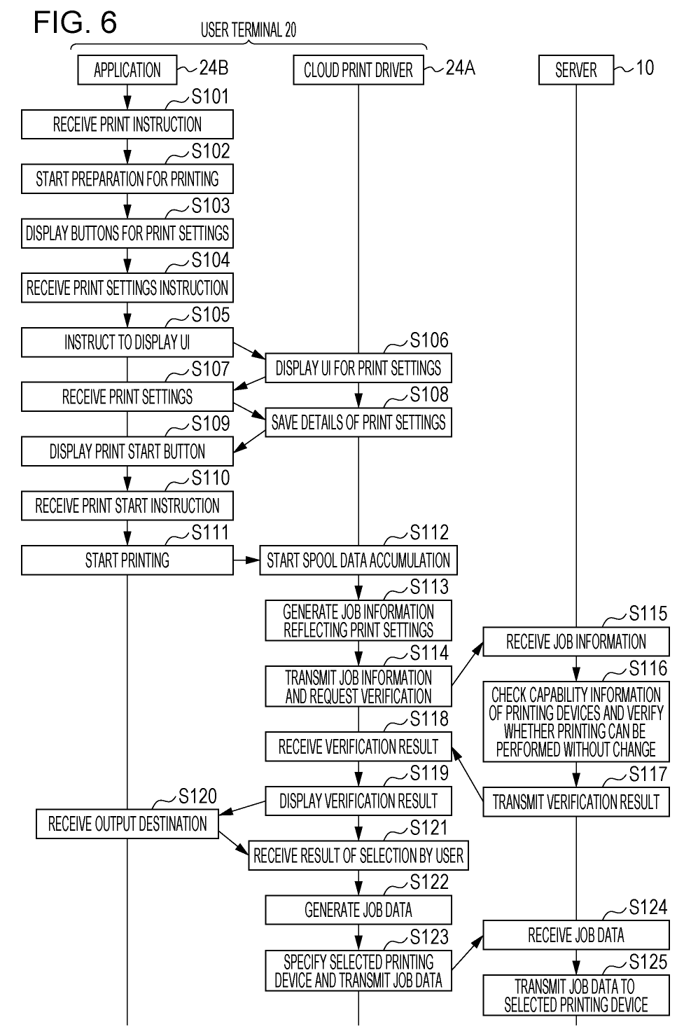

FIG. 6 is a flowchart illustrating an example of a processing procedure when printing using the cloud print service is executed from the user terminal 20.

The processing example illustrated in FIG. 6 illustrates a case where a user creates, for example, document data in the application 24B (see FIG. 4) on the user terminal 20 and prints the document data using the cloud print service.

When receiving a print instruction (step 101), the application 24B starts preparation for printing (step 102). Then, the application 24B displays the buttons for print settings on the display 26 (see FIG. 3) (step 103).

When the user performs an operation on the buttons for print settings, the application 24B receives a print settings instruction (step 104). In response to such a print settings instruction, the application 24B instructs the cloud print driver 24A (see FIG. 4) to display a user interface (UI) for print settings (see FIG. 5) (step 105).

The cloud print driver 24A displays the UI for print settings (see FIG. 5) on the display 26 (see FIG. 3) (step 106). That is, the cloud print driver 24A displays the print settings screen 60 (see FIG. 5) on the display 26 (see FIG. 3).

The application 24B receives the print settings made by the user on the print settings screen 60 (step 107). When the "OK" button 60a (see FIG. 5) in the print settings is operated, the cloud print driver 24A saves the details of the print settings (step 108).

Next, the application 24B displays a print start button on the display 26 (see FIG. 3) (step 109). When the print start button is operated by the user, the application 24B receives a print start instruction (step 110). Then, the application 24B starts printing (step 111).

That is, the application 24B transfers document data to be printed to the cloud print driver 24A as spool data. The application 24B also transfers user-specified information that is information about the print settings specified by the user, to the cloud print driver 24A. The user-specified information is information that is instructed and selected in the color mode setting section 61 and the like of the print settings screen 60.

In this way, the cloud print driver 24A acquires the spool data and the user-specified information from the application 24B.

The cloud print driver 24A starts accumulation of spool data transferred from the application 24B (step 112).

The cloud print driver 24A generates job information in which the user-specified information is reflected in the accumulated spool data (step 113). Such job information is information indicating a job to be executed when the spool data is executed in accordance with the print settings. The job information indicates the details of a job to be executed when the spool data is printed in accordance with the user-specified information. Generation of job information is an example of calculation of information indicating the details of a job.

To be more specific, the job information may be the same as the user-specified information or may be different from the user-specified information. Whether the job information is the same as or different from the user-specified information depends on the spool data.

For example, when the user-specified information indicates color mode and the spool data is monochrome, the job information indicates monochrome mode. When the user-specified information indicates "flip on long edge" and the spool data is one page, the job information indicates "no double-sided printing".

The spool data is an example of data to be printed, and the user-specified information is an example of specified information. The job information is an example of information indicating the details of a job.

The cloud print driver 24A transmits the generated job information to the server 10 and requests verification (step 114). Such verification is to check in advance whether execution of a job is possible with the job information. Such a request is an example of a request to be made to a server device connected to the printing devices.

The execution of a job refers to printing on paper and outputting of the printed paper, and includes post-processing.

When receiving the job information (step 115), the server 10 checks capability information of the printing devices and verifies whether printing can be performed without any change (step 116). Such verification is performed by the above-described print possibility determination unit 16.

The verification result obtained by the print possibility determination unit 16 is transmitted to the cloud print driver 24A (step 117).

When receiving the verification (step 118), the cloud print driver 24A displays the verification result on the display 26 (see FIG. 3) (step 119).

In response to the display of the verification result, the application 24B receives an output destination (step 120). The output destination refers to a printing device that prints the spool data among the printing devices 30A to 30F (see FIG. 1) in the cloud print service.

When receiving the output destination, which is a result of selection by the user (step 121), the cloud print driver 24A generates job data based on the spool data (step 122).

The cloud print driver 24A specifies the selected printing device and transmits the job data to the server 10 (step 123).

When receiving the job data (step 124), the server 10 transmits the job data to the selected printing device (step 125).

In the present exemplary embodiment, since verification is performed in advance, printing in accordance with the print settings specified by the user can be executed by the printing device selected by the user.

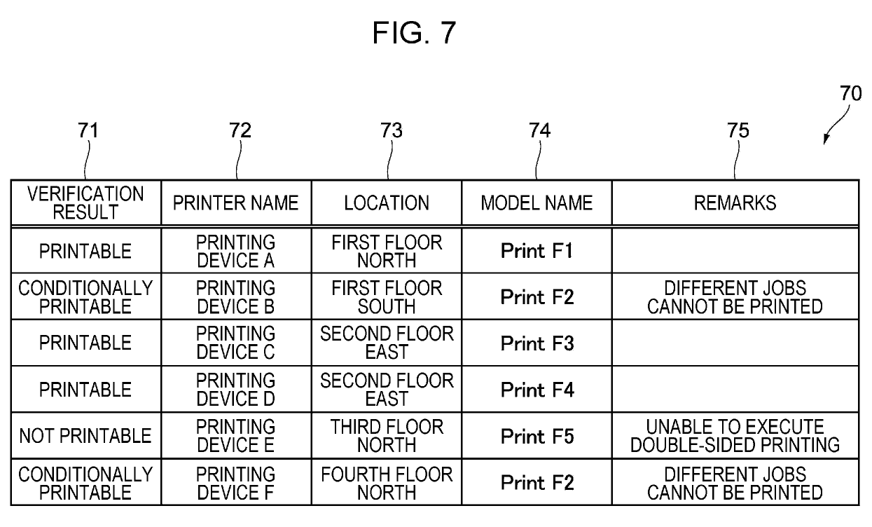

FIG. 7 is a diagram illustrating an example of a verification result 70 obtained by the print possibility determination unit 16 (see FIG. 2). The verification result 70 is an example of a response to a request.

The verification result 70 illustrated in FIG. 7 as an example includes a verification result field 71, a printer name field 72, a location field 73, a model name field 74, and a remarks field 75. As indicated in the printer name field 72, the verification result 70 is for the printing devices A to F (see FIG. 1). That is, the verification result 70 is a result obtained for all of the printing devices 30A to 30F (see FIG. 1) that can use the cloud print service.

The verification result 70 is for a request that does not specify any of the printing devices 30A to 30F connected to the server 10.

The verification result field 71 is a field indicating a result of verification for each of the printing devices 30A to 30F. In the verification result field 71, verification results are distinguished by three verification results of "printable", "not printable", and "conditionally printable". In the present exemplary embodiment, any one of the three verification results is indicated in the verification result field 71. An example may be considered in which either "printable" or "not printable" is indicated. That is, this is an example in which "conditionally printable" is not indicated.

"Printable" and "conditionally printable" as used herein indicate devices that fulfill all of the functions for realizing execution of job data. That is, in the cases of "printable" and "conditionally printable", job data can be executed without changing the print settings.

More specifically, "printable" indicates a printing device that can print current job data and can also print different job data. "Conditionally printable" indicates a printing device that can print current job data but cannot print different job data.

"Not printable" indicates a device that does not fulfill all of the functions for realizing execution of job data.

The printer name field 72 is a field indicating a printer name for identifying the corresponding printing device. The printing devices A to F (see FIG. 1) are displayed in the printer name field 72.

The location field 73 is a field indicating a location where the corresponding printing device is installed.

The model name field 74 is a field indicating the model of the corresponding printing device.

The remarks field 75 is a field indicating reference information for a verification result. In the example illustrated in FIG. 7, with regard to the printing device E that is "not printable", a function that is the cause of non-printability "unable to execute double-sided printing" is reported. With regard to the printing devices B and F that are "conditionally printable", a note "different jobs cannot be printed" is displayed.

While the function that is the cause of non-printability is reported in the remarks field 75, an example may be considered in which such a function is not reported. While a note is displayed in the remarks field 75, an example may be considered in which a note is not displayed.

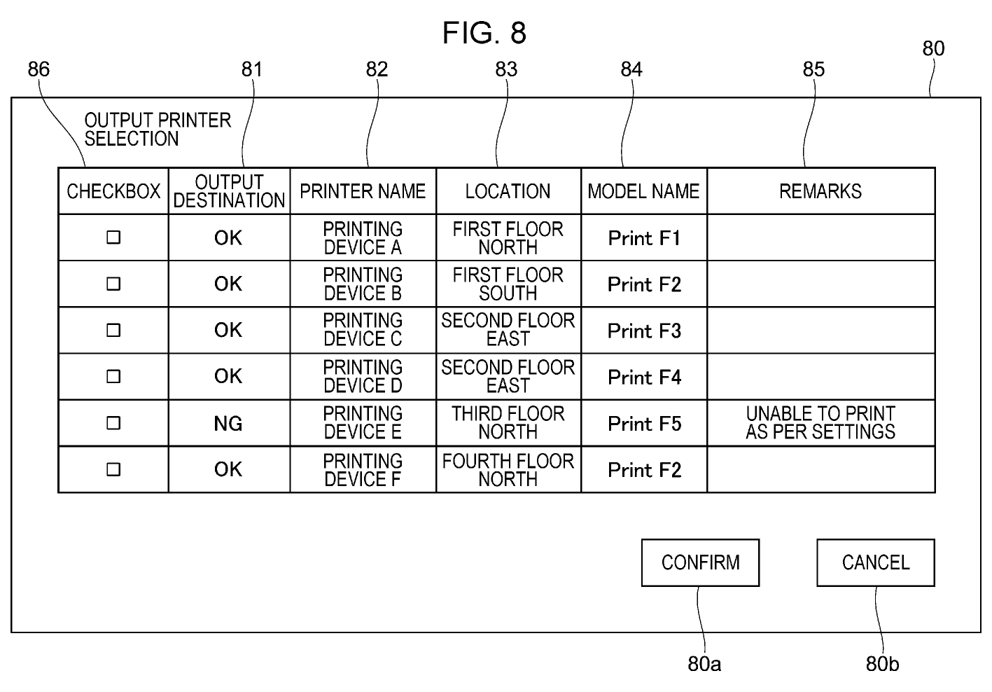

FIG. 8 is a diagram illustrating an example of a screen 80 for output printer selection displayed when the example of the verification result 70 (see FIG. 7) is received (see step 118 in FIG. 6). The screen 80 is displayed on the display 26 (see FIG. 3) when an output destination is received (see step 120 in FIG. 6). Since the screen 80 in FIG. 8 has fields common to the above-described verification result 70, description thereof may be omitted.

The screen 80 is an example of the details of a response.

The screen 80 illustrated in FIG. 8 as an example includes an output destination field 81, a printer name field 82, a location field 83, a model name field 84, a remarks field 85, and a checkbox field 86. The screen 80 also includes a "confirm" button 80a for instructing proceeding to the next screen after an output destination is specified. The screen 80 also includes a "cancel" button 80b for instructing returning to the original screen.

The printer name field 82, the location field 83, and the model name field 84 of the screen 80 correspond to the printer name field 72, the location field 73, and the model name field 74 of the verification result 70 (see FIG. 7).

The output destination field 81 is a field indicating a verification result of output destination. "OK" is displayed in the case of a printable printing device, and "NG" is displayed in the case of a non-printable printing device.

"OK" in the output destination field 81 is displayed for the printing devices A to D and F that are "printable" or "conditionally printable" in the verification result 70. "NG" in the output destination field 81 is displayed for the printing device E that is "not printable" in the verification result 70.

While "OK" is simply displayed in the output destination field 81 without distinguishing "printable" and "conditionally printable" in the verification result 70 from each other in the present exemplary embodiment, "printable" and "conditionally printable" may be distinguished from each other.

With the location field 83 included in the screen 80, a user can specify an output destination in consideration of a distance to pick up the paper output from the printing device or the like. For example, the printing device closest to the current location of the user is selected.

With the model name field 84 included in the screen 80, the user can select a printing device closer to the current location of the user when there are printing devices of the same model. When different models have different functions, the user can specify an output destination based on the model name displayed in the model name field 84.

The remarks field 85 corresponds to the remarks field 75 of the verification result 70 (see FIG. 7).

To be more specific, since the printing device E is a non-printable printing device, a note "unable to print as per settings" is displayed in the remarks field 85. The note in the remarks field 85 is different from the note indicating the cause of non-printability displayed for the printing device E in the verification result 70. Since the user has instructed the execution of double-sided printing, the remarks field 85 does not display the cause but calls attention to the fact of non-printability. The cause of non-printability may be displayed at a timing when the user instructs to do so.

The details in the remarks field 85 may be the same as those in the remarks field 75 of the verification result 70 (see FIG. 7).

The checkbox field 86 is an area in which a checkbox is displayed. The checkbox is for specifying any one of the printing devices A to F as the device to perform printing.

In the checkbox field 86, a checkbox is displayed even for the printing device E that is "NG". This is in consideration of a case where the user wants to change the print settings and perform printing with the printing device E. An example may be considered in which a checkbox is not displayed for the printing device E so that the printing device E is not specified.

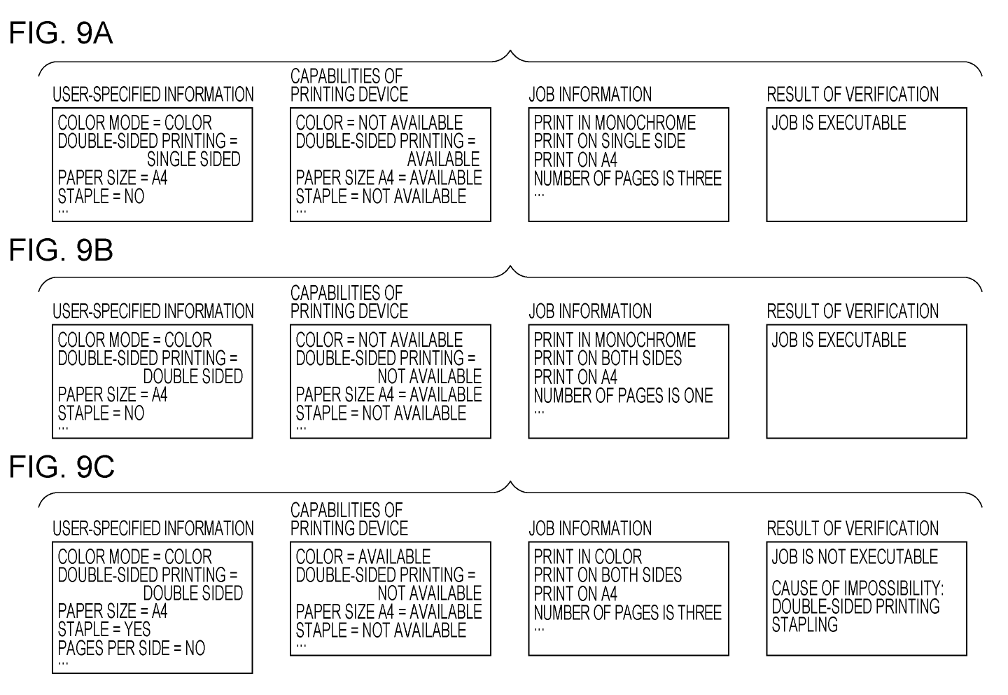

FIGS. 9A, 9B, and 9C are diagrams illustrating a verification method by the print possibility determination unit 16 (see FIG. 2). FIG. 9A illustrates a first example, FIG. 9B illustrates a second example, and FIG. 9C illustrates a third example. Each of FIGS. 9A to 9C illustrates a part of the user-specified information, a part of the capabilities of the printing device, a part of the job information, and the result of verification.

In the first example illustrated in FIG. 9A, the user-specified information includes "color mode = color", "double-sided printing = single sided", "paper size = A4", and "staple = no". According to the user-specified information, color printing is performed on A4 paper, double-sided printing is not performed, and stapling is not performed.

The capabilities of the printing device in the first example include "color = not available", "double-sided printing = available", "paper size A4 = available", and "staple = not available". That is, the printing device can only perform monochrome printing on A4 paper, and can perform double-sided printing but cannot perform stapling.

When the user-specified information is compared with the capabilities of the printing device on a capability-by-capability basis, the result of verification of "not printable" is obtained due to the unavailability of color printing. While the capabilities of the printing device indicate unavailability of stapling, this is not the cause of non-printability since stapling is not performed according to the user-specified information.

However, in the present exemplary embodiment, whether a job is executable is verified based on job information.

The job information in the first example includes "print in monochrome", "print on single side", "print on A4", and "number of pages is three". That is, when spool data is printed, monochrome printing is performed on A4 paper, and double-sided printing is not performed.

For this reason, the spool data can be printed with the capabilities of the printing device without any problem.

Therefore, the print possibility determination unit 16 (see FIG. 2) determines that "job is executable" as the result of verification for the first example.

In the second example illustrated in FIG. 9B, the user-specified information includes "color mode = color", "double-sided printing = double sided", "paper size = A4", and "staple = no". According to the user-specified information, color double-sided printing is performed on A4 paper, and stapling is not performed.

The capabilities of the printing device include "color = not available", "double-sided printing = not available", "paper size A4 = available", and "staple = not available". That is, the printing device can only perform monochrome printing on A4 paper, and cannot perform double-sided printing and stapling.

On the other hand, the job information includes "print in monochrome", "print on both sides", "print on A4", and "number of pages is one". That is, when spool data is printed in the second example, monochrome printing is performed on A4 paper, but double-sided printing is unnecessary since there is only one page.

For this reason, in the second example, the spool data can be printed with the capabilities of the printing device without any problem.

Therefore, the print possibility determination unit 16 (see FIG. 2) determines that "job is executable" as the result of verification for the second example.

In the third example illustrated in FIG. 9C, the user-specified information includes "color mode = color", "double-sided printing = double sided", "paper size = A4", "staple = yes", and "pages per side = no". According to the user-specified information, color double-sided printing is performed on front and back surfaces of A4 paper on a page-by-page basis, and stapling is performed.

The capabilities of the printing device include "color = available", "double-sided printing = not available", "paper size A4 = available", and "staple = not available". That is, the printing device can perform color printing on A4 paper, but cannot perform double-sided printing and stapling.

On the other hand, the job information includes "print in color", "print on both sides", "print on A4", and "number of pages is three". That is, when spool data is printed in the third example, color double-sided printing is performed on A4 paper.

More specifically, since pages-per-side printing is not performed according to the user-specified information, the number of sheets of A4 paper is two. Since stapling is performed according to the user-specified information, two sheets of paper are stapled together.

As described above, in the third example, while double-sided printing and stapling are required, neither double-sided printing nor stapling can be performed according to the capabilities of the printing device. For this reason, the spool data cannot be printed in the third example.

Therefore, the print possibility determination unit 16 (see FIG. 2) determines that "job is not executable" as the result of verification for the third example. "Double-sided printing" and "stapling" are identified as the causes of impossibility.

"Double-sided printing" and "stapling" as used herein are examples of a function that is the cause of non-printability.

In FIGS. 9A to 9C, "paper size A4 = available" in the capability of the printing device includes not only a case where a paper tray for storing A4 paper is provided in the printing device, but also a case where A4 paper is stored in the paper tray. Therefore, when there is no A4 paper stored in the paper tray, that is, in the case of "out of paper", the capability of the printing device is "paper size A4 = not available". For example, when a printing device that performs double-sided printing is provided but the printing device of double-sided printing is out of order, the capability of the printing device is "double-sided printing = single sided".

In this sense, functions that can be realized by a printing device are not the functions of the printing device but refer to the functions that can be currently provided by the printing device in the cloud print service.

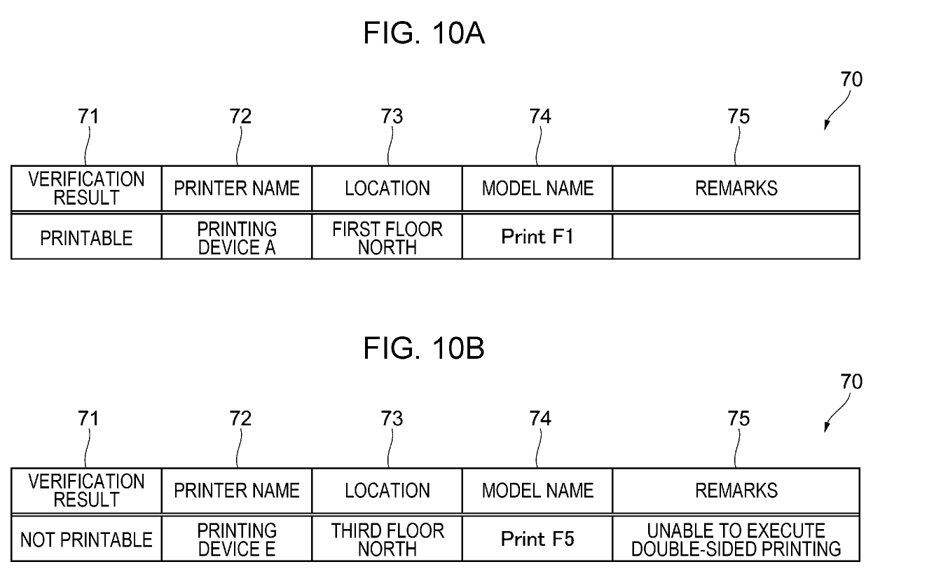

FIGS. 10A and 10B are diagrams illustrating other examples of the verification result 70 obtained by the print possibility determination unit 16 (see FIG. 2). FIG. 10A illustrates a first other example, and FIG. 10B illustrates a second other example. FIGS. 10A and 10B correspond to FIG. 7. The same reference numerals are used for the same sections, and description thereof may be omitted.

Each of the verification results 70 illustrated in FIGS. 10A and 10B is obtained in response to a request made by the user with one of the printing devices 30 (see FIG. 1) specified. While the examples illustrated in FIGS. 10A and 10B are cases where one printing device is specified, the configuration is not limited to these examples. A plurality of printing devices may be specified.

In the first other example illustrated in FIG. 10A, the verification result 70 is for the printing device A. That is, as indicated in the verification result field 71, the printing device A is a printable printing device.

In the second other example illustrated in FIG. 10B, the verification result 70 is for the printing device E. That is, as indicated in the verification result field 71, the printing device E is a non-printable printing device, and as indicated in the remarks field 75, the reason for the impossibility is "unable to execute double-sided printing".

The printing device A in FIG. 10A and the printing device E in FIG. 10B are examples of one or a plurality of printing devices selected from among the printing devices connected to the server device.

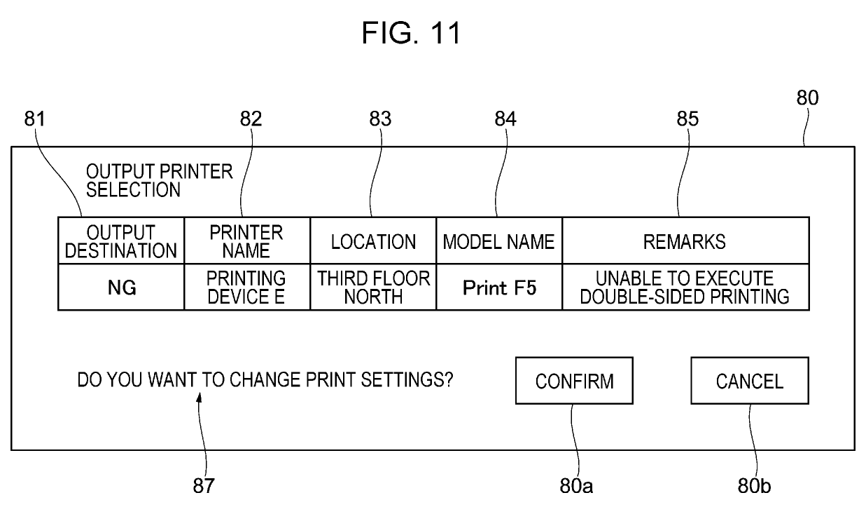

FIG. 11 is a diagram illustrating another example of the screen 80 for output printer selection displayed when the second other example of the verification result 70 (see FIG. 10B) is received (see step 118 in FIG. 6). FIG. 11 corresponds to FIG. 8. The same reference numerals are used for the same sections, and description thereof may be omitted.

In the other example of the screen 80 illustrated in FIG. 11, since the printing device E is a non-printable printing device, the user is asked to confirm whether to change the specified print settings (see FIG. 5). That is, the screen 80 includes a display 87 of "Do you want to change print settings?".

The user recognizes the cause of impossibility "unable to execute double-sided printing" in the remarks field 85. Accordingly, the display 87 prompts the user to determine whether to change the print settings so that the printing device E can perform printing.

When changing the print settings, the user can proceed to the next screen by operating the "confirm" button 80a. On the next screen, for example, the print settings (see FIG. 5) may be displayed.

The user may operate the "cancel" button 80b and select cancellation of the printing.

In addition, in the screen 80, the user may be prompted to select whether to re-specify a printing device other than the printing device E.

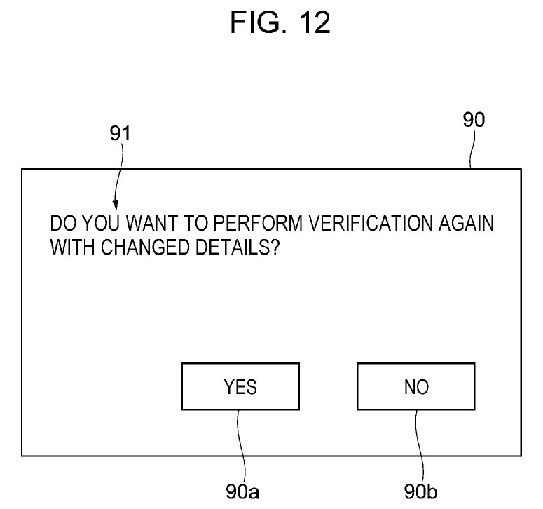

FIG. 12 is a diagram illustrating a screen example 90 displayed after the print settings (see FIG. 5) are changed. The screen example 90 illustrated in FIG. 12 is displayed after the "confirm" button 80a in the screen 80 of FIG. 11 is operated.

As illustrated in FIG. 12, the screen example 90 includes a display 91 of "Do you want to perform verification again with changed details?". In the case of requesting verification, the user presses a "yes" button 90a. In the case of not requesting verification, the user presses a "no" button 90b.

When the "yes" button 90a in the screen example 90 is pressed, the processing of step 113 and subsequent steps in the above-described processing procedure example (see FIG. 6) is performed.

That is, user-specified information changed by the user is acquired for the changed print settings. Then, job information for a job to be executed when spool data is printed in accordance with the user-specified information is generated using the spool data and the acquired user-specified information. After that, the generated job information is transmitted to the server 10 (see FIG. 1), and a verification request is made again.

The screen example 90 is an example of confirmation display. The display 91 is an example of display that prompts the user to input whether to request the server device to perform verification.

While the cloud print driver 24A generates job data and transmits the job data to the server 10 after verification in the present exemplary embodiment (see step 123 in FIG. 6), the configuration is not limited to such a case. For example, an example may be considered in which the job data is transmitted to the server 10 when job information is transmitted (see step 114 in FIG. 6). Another example may be considered in which the job data is transmitted in parts at the time when the job information is transmitted and after verification.

While a user selects whether to make a verification request again in the present exemplary embodiment, the configuration is not limited to such a case. An example may be considered in which a verification request is always made again.

There are cases where predetermined printing conditions are restricted according to a user who logs in to the cloud print service. An example is a case where a user Y is not permitted to perform color printing while a user X is permitted to perform color printing. Information indicating such a restriction on the printing conditions is stored in the login list 14B of the server 10.

Therefore, in such cases, the print possibility determination unit 16 determines whether printing is possible or not based on the authentication information of a logged-in user.

In the present exemplary embodiment, the printer driver system 100 (see FIG. 4) can be regarded as a print control system. The user terminal 20 including the printer driver system 100 can be regarded as an information processing device. Further, the server 10 including the printer driver system 100 can be regarded as a print server.

The cloud print driver 24A in the present exemplary embodiment can be regarded as a printer driver.

While the exemplary embodiment of the present disclosure has been described above, the technical scope of the present disclosure is not limited to the scope described in the above exemplary embodiment. It is apparent from the description of claims that various modifications and improvements made to the above exemplary embodiment are included in the technical scope of the present disclosure.

The present disclosure may also be applied to a program and a program product.

### Appendix

### (((1)))

A print control system comprising: a processor configured to: hold print settings that do not specify printing devices; acquire data to be printed and specified information about the print settings specified by a user in instructing a server device to print the data; calculate information indicating details of a job to be executed when the data is printed in accordance with the specified information, using the data and the specified information that have been acquired; and request the server device connected to the printing devices to verify whether the job is executable with the information that has been calculated.

### (((2)))

The print control system according to (((1))), wherein the print settings reflect functions that can be realized by at least one printing device among the printing devices connected to the server device, and the processor is configured to, when a response to the request is received, report details of the received response to the user, the response indicating a printable printing device that satisfies all of functions that realize execution of the job and/or a non-printable printing device that does not satisfy all of the functions that realize execution of the job.

### (((3)))

The print control system according to (((2))), wherein when the request is for one or a plurality of printing devices selected from among the printing devices connected to the server device, the response indicates the printable printing device and/or the non-printable printing device, for the one or plurality of printing devices.

### (((4)))

The print control system according to (((2))), wherein when the request does not specify any of the printing devices connected to the server device, the response indicates the printable printing device and/or the non-printable printing device for each of the printing devices.

### (((5)))

The print control system according to any one of (((2))) to (((4))), wherein when the response includes the non-printable printing device and a function that is a cause of non-printability, the function that is the cause of non-printability is reported when the details of the received response are reported to a user.

### (((6)))

The print control system according to any one of (((2))) to (((5))), wherein when the response includes the non-printable printing device, the report includes confirmation display that checks whether to change user specification for the print settings.

### (((7)))

The print control system according to (((6))), wherein the confirmation display includes display that prompts the user to input whether to request the server device to perform the verification when the user specification is changed.

### (((8)))

The print control system according to (((7))), wherein when there is the input that requests the server device to perform the verification, the processor is configured to: acquire the specified information that has been changed by the user for the print settings; calculate information indicating details of a job to be executed when the data is printed in accordance with the changed specified information, using the data and the changed specified information; and transmit the information that has been calculated to the server device and make the request.

### (((9)))

A program causing an information processing device that holds print settings that do not specify printing devices to execute a process comprising: acquiring data to be printed and specified information about the print settings specified by a user in instructing a server device to print the data; calculating information indicating details of a job to be executed when the data is printed in accordance with the specified information, using the data and the specified information that have been acquired; and requesting the server device connected to the printing devices to verify whether the job is executable with the information that has been calculated.

### (((10)))

An information processing device comprising: a holding unit configured to hold print settings that do not specify printing devices; an acquisition unit configured to acquire data to be printed and specified information about the print settings specified by a user in instructing a server device to print the data; a calculation unit configured to calculate information indicating details of a job to be executed when the data is printed in accordance with the specified information, using the data and the specified information that have been acquired; and a request unit configured to request the server device connected to the printing devices to verify whether the job is executable with the information that has been calculated.

### (((11)))

A print server configured to: hold print settings that do not specify printing devices; acquire data to be printed and specified information about the print settings specified by a user in instructing a server device to print the data; calculate information indicating details of a job to be executed when the data is printed in accordance with the specified information, using the data and the specified information that have been acquired; and request the server device connected to the printing devices to verify whether the job is executable with the information that has been calculated.

### (((12)))

A printer driver configured to: hold print settings that do not specify printing devices; acquire data to be printed and specified information about the print settings specified by a user in instructing a server device to print the data; calculate information indicating details of a job to be executed when the data is printed in accordance with the specified information, using the data and the specified information that have been acquired; and request the server device connected to the printing devices to verify whether the job is executable with the information that has been calculated.

What is claimed is:

1. A print control system comprising:
a processor configured to:
hold print settings that do not specify printing devices;
acquire data to be printed and specified information about the print settings specified by a user in instructing a server device to print the data;
calculate information indicating details of a job to be executed when the data is printed in accordance with the specified information, using the data and the specified information that have been acquired; and
request the server device connected to the printing devices to verify whether the job is executable with the information that has been calculated.

2. The print control system according to claim 1, wherein
the print settings reflect functions that can be realized by at least one printing device among the printing devices connected to the server device, and
the processor is configured to, when a response to the request is received, report details of the received response to the user, the response indicating a printable printing device that satisfies all of functions that realize execution of the job and/or a non-printable printing device that does not satisfy all of the functions that realize execution of the job.

3. The print control system according to claim 2, wherein
when the request is for one or a plurality of printing devices selected from among the printing devices connected to the server device,
the response indicates the printable printing device and/or the non-printable printing device, for the one or plurality of printing devices.

4. The print control system according to claim 2, wherein
when the request does not specify any of the printing devices connected to the server device,
the response indicates the printable printing device and/or the non-printable printing device for each of the printing devices.

5. The print control system according to claim 2, wherein
when the response includes the non-printable printing device and a function that is a cause of non-printability,
the function that is the cause of non-printability is reported when the details of the received response are reported to a user.

6. The print control system according to claim 2, wherein
when the response includes the non-printable printing device,
the report includes confirmation display that checks whether to change user specification for the print settings.

7. The print control system according to claim 6, wherein
the confirmation display includes display that prompts the user to input whether to request the server device to perform the verification when the user specification is changed.

8. The print control system according to claim 7, wherein
when there is the input that requests the server device to perform the verification,
the processor is configured to:
acquire the specified information that has been changed by the user for the print settings;
calculate information indicating details of a job to be executed when the data is printed in accordance with the changed specified information, using the data and the changed specified information; and
transmit the information that has been calculated to the server device and make the request.

9. A non-transitory computer readable medium storing a program causing a computer of an information processing device that holds print settings that do not specify printing devices to execute a process comprising:
acquiring data to be printed and specified information about the print settings specified by a user in instructing a server device to print the data;
calculating information indicating details of a job to be executed when the data is printed in accordance with the specified information, using the data and the specified information that have been acquired; and
requesting the server device connected to the printing devices to verify whether the job is executable with the information that has been calculated.

10. An information processing device comprising:
a holding unit configured to hold print settings that do not specify printing devices;
an acquisition unit configured to acquire data to be printed and specified information about the print settings specified by a user in instructing a server device to print the data;
a calculation unit configured to calculate information indicating details of a job to be executed when the data is printed in accordance with the specified information, using the data and the specified information that have been acquired; and
a request unit configured to request the server device connected to the printing devices to verify whether the job is executable with the information that has been calculated.

11. A print server configured to:
hold print settings that do not specify printing devices;
acquire data to be printed and specified information about the print settings specified by a user in instructing a server device to print the data;
calculate information indicating details of a job to be executed when the data is printed in accordance with the specified information, using the data and the specified information that have been acquired; and
request the server device connected to the printing devices to verify whether the job is executable with the information that has been calculated.

12. A printer driver configured to:
hold print settings that do not specify printing devices;
acquire data to be printed and specified information about the print settings specified by a user in instructing a server device to print the data;
calculate information indicating details of a job to be executed when the data is printed in accordance with the specified information, using the data and the specified information that have been acquired; and
request the server device connected to the printing devices to verify whether the job is executable with the information that has been calculated.
